(19) United States
(12) Patent Application Publication
(10) Pub. No.: US 2022/0250918 A1
(43) Pub. Date: Aug. 11, 2022

(54) METHOD FOR PURIFYING SILICON CARBIDE

(71) Applicant: ESK-SIC GMBH, Frechen (DE)

(72) Inventors: Matthias HAUSMANN, Köln (DE); Wenzel KLIETZ, Köln (DE); Josef GARBES, Bergheim (DE)

(21) Appl. No.: 17/626,062

(22) PCT Filed: Jul. 7, 2020
(86) PCT No.: PCT/EP2020/069085

§ 371 Date: Jan. 10, 2022

(30) Foreign Application Priority Data
Jul. 11, 2019 (DE) 10 2019 118 866.0
Nov. 22, 2019 (DE) 10 2019 131 592.1

(51) Int. Cl. C01B 32/956

(52) U.S. Cl. CPC C01B 32/956; C01P 2006/80; C01P 2004/61

(57) ABSTRACT

A method for purifying powdered silicon carbide as a starting product to form a silicon carbide with a level of purity of at least 99.9% includes the following method steps:
providing a starting product with a silicon carbide content with at least 98% purity and a grain size of less than 100 μm, and
   heating the starting product under vacuum or in an oxygen-free atmosphere to a temperature of more than 1700° C. over a period of time of at least 8 minutes.

### TECHNICAL FIELD

The disclosure relates to the field of production of raw materials for the semiconductor and electronics industry and relates to a method for purifying powdered silicon carbide as a starting product to form a silicon carbide with a level of purity of at least 99.9%.

### BACKGROUND

Silicon carbide (SiC) is an extremely hard, temperature-resistant synthetic industrial material. On account of its hardness and the high melting point, it is used as an abrasive (carborundum, for example optical mirrors and lenses) and as a component for refractory materials. However, the use as semiconductor material is also significant. Besides the application as LED and photodiode, SiC is used for varistors, ultrafast Schottky diodes, insulating-layer and barrier-layer field-effect transistors and electronic circuits and sensors based therein, which have to withstand high temperatures or high doses or ionising radiation. SiC-based semiconductor circuits can be employed under laboratory conditions at temperatures up to 600° C. Silicon carbide is also employed in particular in automotive and environmental technology, for example for the manufacture of diesel particulate filters.

Depending on the production technique, a distinction can be made in silicon carbide ceramics between self-bonded and second-phase bonded ceramics, and between open-porous and dense ceramic. The type and proportion of the binding methods are key for the particular characteristic properties of the silicon carbide ceramics.

The production can be realised for example by what is known as the Acheson process. In the Acheson process an elongate tray of shaped artificial carbon bodies is embedded in powdered coke and is then covered with sand. The shaped bodies are connected to electrodes and an electrical current is applied, which heats the shaped bodies to 2200-2400° C., whereby sufficient energy is provided to produce hexagonal α-silicon carbide from silicon dioxide in an endothermic reaction.

Highly pure SiC crystals for electronic applications and semiconductor technology are usually produced in accordance with the prior art from SiC substrate powders by means of a physical vapour deposition. This sublimation and recondensation process takes place at temperatures >2000° C. The physical vapour transport is supported by a temperature difference between seed crystal and starting material. The starting material acted on by higher temperature thus deposits on the seed crystal. The application of thin SiC layers on prefabricated semiconductor components is also possible by means of the same process path with the starting product of substrate powder.

The further processing to form the grain sizes ultimately required is performed by grinding, purification and fractionation in corresponding grain ranges.

Alternatively and/or additionally, it is also possible to recover silicon carbide from recycling processes from impure silicon carbide. In particular, the level of purity of silicon carbide is crucial for its further processing. A level of purity of practically 100% is required for numerous applications, which makes corresponding methods for purifying or enriching the starting material complex and costly.

Impurities in silicon carbide are inorganic (non-metallic and inorganic metallic impurities).

In particular, physical and chemical processing methods are known to increase the level of purity of the product. Physical methods are suitable in particular for the deposition of magnetic iron impurities or impurities with different particle size and density.

In chemical methods, the solubility of impurities is usually used for separation. Here, it is advantageous that silicon carbide is very stable in respect of chemicals.

Lastly, thermal methods can also be used, for example the oxidation of free carbon under air.

DE 10 2013 218 450 A1 describes a method for recycling powdered silicon carbide waste products in which powdered SiC waste products comprising at least 50 mass % SiC and having a mean grain size d₅₀, measured by means of laser diffraction, between 0.5 and 500 μm, are subjected to a temperature treatment under vacuum or in an oxygen-free atmosphere at temperatures of at least 2000° C. This method causes the silicon carbide particles to enlarge and thus be usable again for a series of applications. The method primarily solves the problem of making silicon carbide with an excessively small particle size usable again for further products. Increasing the level of purity is thus only indirectly possible with this method.

### SUMMARY

The problem addressed by the present disclosure lies in proposing a method for increasing the level of purity of silicon carbide. The method shall make it possible to convert a silicon carbide starting product with a level of purity of more than 98%, preferably of more than 99%, into a highly pure silicon carbide product with a level of purity of at least 99.9%. It shall be possible to carry out the method economically and easily.

The problem is solved by a method having the method steps of independent claim 1. Advantageous embodiments are the subject matter of the dependent claims.

The method according to the disclosure has the following method steps
providing a starting product with a silicon carbide content with at least 98% purity and a grain size of less than 100 μm,
heating the starting product under vacuum or in an oxygen-free atmosphere to a temperature of more than 1700° C. over a period of time of at least 8 minutes.

The main finding of the disclosure lies in the fact that it is possible to increase significantly the level of purity of a suitable silicon carbide starting product (hereinafter: starting product) by means of a thermal method. This results in a highly pure silicon carbide product (hereinafter: product) with a level of purity of at least 99.9%, preferably much higher. The level of purity relates here to pure silicon carbide in the product.

For example, loose silicon carbide powder in bulk material form is a suitable starting product for the highly pure silicon carbide product to be produced. However, it is also possible to use powder that is slightly compacted. The bulk material or the compacted powder can preferably have a proportional density, in relation to the true density of the powder or the powder mixture, up to a maximum of 50%. Particularly suitable starting products have a density between 20 and 50%, advantageously between 25 and 40%.

A bulk material can be produced by filling loose powder into a container or by heaping onto a substrate surface. In so doing, the material can be distributed using simple mechanical aids. A slight compaction can be achieved for example by using vibrations, for example by a vibrating table or by beating.

The density of the starting product, that is to say of the bulk material or of the powder, is determined by weighing and determining the volume of the bulk material. The true density can be determined for example by gas pycnometry. If the composition is known, the density can also be calculated from the known true density of the components. The true density of silicon carbide is, for example, 3.21 g/cm³.

The grain size of the starting product is less than 100 μm, preferably less than 70 μm. The powder used as starting product can either be obtained commercially on the market and/or can be chemically pre-treated.

The starting product is subjected to a temperature treatment under vacuum or in an oxygen-free atmosphere at temperatures of more than 1700° C. The temperatures advantageously lie between 1800° C. and 2300° C., in particular at approximately 1900° C. to 2100° C.

A key advantage of the method according to the disclosure lies in particular in the fact that fractionation of the product is not necessary at any time. This leads both to a significant simplification of the method, and to a considerable cost reduction. Ultimately, the product can be further processed in the form in which it is present after the thermal treatment. This is also then true in particular if, for example, changes to the grain sizes or volume changes due to baked-on material have resulted from the thermal treatment and/or the transport of the starting product through the oven. Such changes no longer have an influence on the level of purity of the product. The starting product is merely thermally treated and optionally chemically purified; the resultant product is not subjected to any secondary treatment, in particular is not fractionated.

The thermal treatment is possible both in batch ovens and in continuous throughfeed operation. The duration of the thermal treatment, that is to say the holding time at the correspondingly high temperature, is advantageously between approximately 8 minutes and 400 minutes at the stated temperatures. The duration is dependent here, inter alia, on the physical properties of the starting product (for example the grain size), on the volume to be treated and on the temperature of the oven.

Technical protective gas atmospheres, such as an argon atmosphere, are preferably used as an oxygen-free atmosphere. The thermal treatment is possible here under a slight positive pressure and under negative pressure, up to a vacuum. It has been found that particularly good results are achieved if the thermal treatment is performed under vacuum, preferably under a rough vacuum, in particular at approximately 10 mbar. The pressure levels are varied according to the operation mode depending on temperature.

The level of purity of the product is advantageously determined by a suitable method following the thermal treatment. This generally lies already at more than 99.9%. Should the level of purity be insufficient, a chemical purification can advantageously follow. It may be necessary to size-reduce the thermally treated silicon carbide in order to break up any potential caking.

A chemical purification is possible in accordance with the disclosure also prior to the first thermal treatment depending on the quality of the starting product and is expedient in order to remove initial impurities.

The chemical purification is advantageously performed in a chemical reactor. For example, hydrofluoric acid (HF), nitric acid (HNO3), phosphoric acid (H3PO4), sulphuric acid (H2SO4), hydrochloric acid (HCl), sodium hydroxide (NaOH), ammonia (NH4OH) or similar acidic or basic compounds is/are used, the acids generating a pH value of 0 and the bases generating a pH value of 14.

### BRIEF DESCRIPTION OF THE DRAWINGS

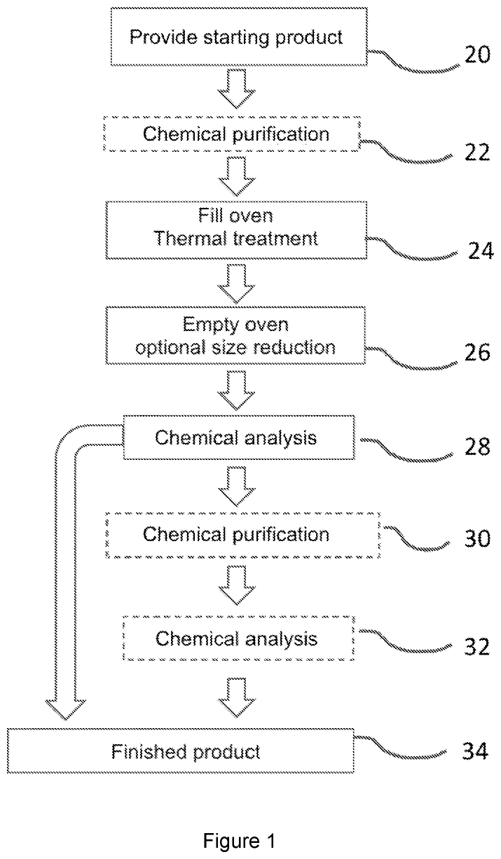

The method will be explained in greater detail on the basis of the accompanying FIG. 1.

### DETAILED DESCRIPTION

In a first method step 20, a silicon carbide starting product with a level of purity of more than 98%, preferably more than 99%, is provided. The starting product does not have to be present in different individual fractions, rather a single fraction is sufficient.

In a next, optional method step 22, a first chemical purification can be performed. in order to separate impurities. This method step is dependent on the present starting product; the first chemical purification can be omitted if the level of purity of the starting product is sufficient.

As the next method step 24, the oven is filled and the thermal treatment of the starting product is performed. The starting product is heated here with each oven run to at least 1700° C., advantageously to at least 1900° C. to 2100° C. under an argon atmosphere and a rough vacuum. The temperature is held for at least 8 minutes, however, the holding time of the temperature can also be up to approximately 400 minutes.

The oven is then emptied. The thermally treated silicon carbide is optionally size-reduced in order to break up any baked-on material or caking (method step 26).

The thermally treated silicon carbide is then chemically analysed; in particular, the level of purity is determined by means of a suitable method (method step 28).

Should the level of purity still be too low, a chemical purification (as necessary, the second chemical purification) can be performed in an optional next method step 30.

The purity content is checked again by means of a final chemical analysis (method step 32). If the purity content is sufficient, the finished product 34 according to the disclosure can be fed to a further use.

The method according to the disclosure offers numerous advantageous compared to methods that are already known. In particular, considerable costs can be saved with the method according to the disclosure. In addition, in the optimal case, merely a thermal treatment of a suitable starting product is necessary. The method can thus be performed quickly and easily.

1. A method for purifying powdered silicon carbide as a starting product to form a silicon carbide with a level of purity of at least 99.9%, the method having the following steps:
providing a starting product with a silicon carbide content with at least 98% purity and a grain size of less than 100 μm, and
heating the starting product under vacuum or in an oxygen-free atmosphere to a temperature of more than 1700° C. over a period of time of at least 8 minutes.

2. The method according to claim 1, wherein the period of time of the heating is up to 400 minutes.

3. The method according to claim 1, wherein the starting product is heated to 1800° C. to 2300° C.

4. The method according to claim 1, wherein the starting product has a grain size of less than 70 μm.

5. The method according to claim 1, wherein the product remains in a single fraction following the heating.

6. The method according to claim 1, wherein the heating is performed in a rough vacuum at approximately 10 mbar.

7. The method according to claim 1, wherein a chemical purification of the silicon carbide is performed prior to the heating.

8. The method according to claim 1, wherein a chemical purification of the silicon carbide follows the heating.

9. The method according to claim 7, wherein the chemical purification is performed in a chemical reactor using a chemical from the group of hydrofluoric acid (HF), nitric acid (HNO3), phosphoric acid (H3PO4), sulphuric acid (H2SO4), hydrochloric acid (HCl), sodium hydroxide (NaOH), ammonia (NH4OH) or a correspondingly acidic or basic compound.
